(19) United States
(12) Patent Application Publication
(10) Pub. No.: US 2012/0183124 A1
(43) Pub. Date: Jul. 19, 2012

(54) GRID FOR RADIOGRAPHY, RADIATION IMAGE DETECTOR, RADIATION IMAGING SYSTEM, AND METHOD FOR MANUFACTURING GRID

(75) Inventor: Yasuhisa KANEKO, Ashigarakami-gun (JP)

(73) Assignee: FUJIFILM CORPORATION, Tokyo (JP)

(21) Appl. No.: 13/341,550

(22) Filed: Dec. 30, 2011

(30) Foreign Application Priority Data
Jan. 17, 2011 (JP) 2011-006649

(51) Int. Cl. G01N 23/04; G21K 3/00; G21K 1/00

(52) U.S. Cl. 378/62; 378/154; 216/24; 216/25

(57) ABSTRACT

Periodic electrodes in a pattern of many lines are formed on a first surface of a nonlinear single crystal substrate. The nonlinear single crystal substrate is put in a vacuum chamber, and heated with a heater. Then, high voltage is applied to the nonlinear single crystal substrate. Thus, the direction of spontaneous polarization of the nonlinear single crystal substrate is reversed in portions facing to the periodic electrodes, which are referred to as reversed portions. After the nonlinear single crystal substrate is bonded to a support substrate, only non-reversed portions of the nonlinear single crystal substrate are removed by wet etching, and grooves with a high aspect ratio are left between the remaining reversed portions. The grooves are filled with an X-ray absorbing material such as gold. The grooves filled with the gold compose X-ray absorbing portions of a grid, while the reversed portions compose X-ray transparent portions.

### BACKGROUND OF THE INVENTION

1. Field of the Invention

The present invention relates to a grid for radiography, a manufacturing method of the grid, and a radiation image detector and a radiation imaging system using this grid.

2. Description Related to the Prior Art

When radiation, for example, X-rays are incident upon an object, the intensity and phase of the X-rays are changed by interaction between the X-rays and the object. At this time, the phase change of the X-rays is larger than the intensity change. Taking advantage of these properties of the X-rays, X-ray phase imaging is developed and actively researched to allow obtainment of a high-contrast image (hereinafter called phase contrast image) of a sample having low X-ray absorptivity based on the phase change (angular change) of the X-rays caused by the sample.

There is proposed an X-ray imaging system for carrying out the X-ray phase imaging using the Talbot effect, which is produced with two transmissive diffraction gratings or grids (refer to Japanese Patent Laid-Open Publication No. 2006-259264 and Applied Physics Letters Vol. 81, No. 17, page 3287 written by C. David et al. on October 2002, for example). In this X-ray imaging system, a first grid is disposed behind a sample when viewed from the side of an X-ray source, and a second grid is disposed downstream from the first grid by the Talbot distance. Behind the second grid, an X-ray image detector (flat panel detector: FPD) is disposed to detect X-rays and produce an image. Each of the first and second grids, being a stripe-patterned one-dimensional grid, has X-ray absorbing portions and X-ray transparent portions that extend in a first direction and are alternately arranged in a second direction orthogonal to the first direction. The Talbot distance refers to a distance at which the X-rays having passed through the first grid form a self image (fringe image) of the first grid by the Talbot effect.

In the above X-ray imaging system, fringe images, which are produced by superimposition (intensity modulation) of the second grid on the self image of the first grid, are detected by a fringe scanning method, in order to obtain phase information of the sample from variation in the fringe images due to the sample. In the fringe scanning method, the X-ray image detector captures the image, whenever the second grid is translationally moved relative to the first grid in the second direction at a scan pitch that is an integral submultiple of a grid pitch. From the change of each pixel value of the images, the angular distribution of the X-rays refracted by the sample, in other words, a differential image of a phase shift is obtained. Based on this angular distribution, the phase contrast image of the sample is obtained. The fringe scanning method is also applied to an imaging system using laser light (refer to Applied Optics Vol. 37, No. 26, page 6227 written by Hector Canabal et al. on September 1998, for example).

The first and second grids have minute structure such that the width and arrangement pitch of the X-ray absorbing portions are several micrometers. Also, the X-ray absorbing portions of the first and second grids require high X-ray absorptivity. Especially, the second grid requires higher X-ray absorptivity than that of the first grid, in order to reliably apply the intensity modulation to the fringe image. For these reasons, the X-ray absorbing portions of the first and second grids are made of gold (Au) having high atomic weight. Moreover, the X-ray absorbing portions of the second grid require a relatively large thickness in an X-ray propagation direction, that is, a so-called high aspect ratio (a value that the thickness of the X-ray absorbing portion is divided by the width thereof).

The Japanese Patent Laid-Open Publication No. 2006-259264 discloses a manufacturing method of the second grid in which grooves are formed in a photosensitive resin layer provided on a substrate by X-ray lithography (for example, LIGA method), and an X-ray absorbing material such as Au is charged into the grooves by electrolytic plating or the like. There is also known a method in which grooves are formed by dry etching in a substrate of silicon or the like, and the X-ray absorbing material such as Au is charged into the grooves.

Conventionally, there is proposed a method for producing a minute periodic structure in which a nonlinear single crystal is subjected to polarization inversion by corona charging (refer to Japanese Patent Laid-Open Publication No. 2002-334977 and Applied Physics Letters Vol. 69, No. 18, page 2629 written by A. Harada et al. in 1996, for example). The polarization inversion by the corona charging is performed along a crystallographic axis of the nonlinear single crystal with extremely high perpendicularity, and hence facilitates production of the periodic structure of the high aspect ratio.

In the X-ray lithography, the photosensitive resin layer has to be exposed to synchrotron radiation with high directivity. However, few facilities can perform the exposure to the synchrotron radiation, and the exposure takes long time and yields low throughput. Also, the method using the dry etching needs high cost and yields low throughput.

The polarization inversion, as described above, yields high throughput at low cost, as compared to the LIGA method using the synchrotron radiation and the dry etching. Thus, it is conceivable that forming the grid by the polarization inversion will be of great benefit. However, neither the Japanese Patent Laid-Open Publication No. 2002-334977 nor the Applied Physics Letters Vol. 69, No. 18, page 2629 discloses a concrete method for producing the grid.

### SUMMARY OF THE INVENTION

An object of the present invention is to provide a grid that is produced by polarization inversion of nonlinear single crystal.

To achieve the above and other objects of the present invention, a grid for radiography according to the present invention includes a plurality of radiation transparent portions made of nonlinear single crystal, and a plurality of radiation absorbing portions arranged alternately to the radiation transparent portions. The radiation transparent portions may be doped with a phosphor, and emit light upon application of radiation. The radiation transparent portions and the radiation absorbing portions may be inclined such that radiation incident from behind the grid converges to a focus of the radiation. It is preferable that the radiation absorbing portions and the radiation transparent portions extend in a first direction, and are alternately arranged in a second direction orthogonal to the first direction.

A radiation image detector according to the present invention includes a grid and a photodetector. The grid includes a plurality of radiation transparent portions and a plurality of radiation absorbing portions. The radiation transparent portions are made of nonlinear single crystal doped with a phosphor to emit light upon application of radiation. The photodetector detects the light emitted from the grid. The radiation image detector may further include a scan mechanism for moving the grid at a predetermined pitch in an arrangement direction of the radiation absorbing portions and the radiation transparent portions.

A radiation imaging system according to the present invention includes a radiation source for emitting radiation, a first grid, an intensity modulator, a radiation image detector, and a computing section. The first grid passes the radiation from the radiation source to form a first periodic pattern image. The first grid includes alternately arranged first radiation transparent portions and first radiation absorbing portions. The first radiation transparent portions are made of nonlinear single crystal. The intensity modulator applies intensity modulation to the first periodic pattern image at least one relative position out of phase with the first periodic pattern image to form a second periodic pattern image. The radiation image detector detects the second periodic pattern image. The computing section images phase information of the radiation based on the second periodic pattern image detected by the radiation image detector.

The intensity modulator may include a second grid and a scan mechanism. The second grid has alternately arranged second radiation transparent portions and second radiation absorbing portions. The second radiation transparent portions are made of nonlinear single crystal. The scan mechanism moves one of the first and second grids at a predetermined pitch in a periodic direction of grid structure to set the first and second grids at the relative position.

The radiation imaging system may further include a third grid disposed between the radiation source and the first grid. The third grid partly blocks the radiation emitted from the radiation source to form many line sources. The third grid includes alternately arranged third radiation transparent portions and third radiation absorbing portions. The third radiation transparent portions are made of nonlinear single crystal.

The radiation image detector may include a second grid and a photodetector. The second grid has second radiation transparent portions and second radiation absorbing portions. The second radiation transparent portions are made of nonlinear single crystal doped with a phosphor and emit light upon application of the radiation. The photodetector detects the light emitted from the second grid. The intensity modulator is a scan mechanism for moving the second grid at a predetermined pitch in an arrangement direction of the second absorbing portions and the second transparent portions.

A method for manufacturing a grid for radiography includes the steps of forming a plurality of first electrodes on a first surface of a nonlinear single crystal substrate after being subjected to a polling process; applying voltage to the nonlinear single crystal substrate from aside of a second surface opposite to the first surface, to reverse a direction of polarization of the nonlinear single crystal substrate in portions facing to the first electrodes; etching the nonlinear single crystal substrate, and removing non-reversed portions where polarity inversion has not occurred while keeping reversed portions where the polarity inversion has occurred, by taking advantage of difference in an etching rate between the non-reversed portions and the reversed portions; and charging a radiation absorbing material into space left after the removal of the non-reversed portions. The method may further include the step of doping the reversed portions with a phosphor. Moreover, the method may further include the step of forming second electrodes on the second surface of the nonlinear single crystal substrate with periodicity different from that of the first electrodes. In this case, the voltage is applied to the second electrodes.

According to the grid for radiography of the present invention, the radiation transparent portions are made of the nonlinear single crystal composed of two or more elements. This is effective at preventing the diffusion of gold from the radiation absorbing portions into the radiation transparent portions, as compared with a case where the radiation transparent portions are made of nonlinear single crystal composed of a single element such as silicon. This is because the single crystal composed of the single element easily reacts due to a low bonding strength and tends to allow the diffusion, while the nonlinear single crystal composed of the two or more elements has a higher bonding strength between the different types of elements than that between the single type of elements. Thus, using the nonlinear single crystal composed of the two or more types of elements facilitates preventing the diffusion of the gold. Also, since the radiation absorbing portions and the radiation transparent portions are inclined so as to converge to the focus of the radiation, the vignetting of a cone beam of radiation is reduced.

According to the grid of the present invention, the radiation transparent portions are doped with the phosphor, and emit the light upon application of the radiation. Thus, the grid functions as a scintillator of the radiation image detector. Since the single crystal has higher filling density than that of a polycrystal, luminous efficiency becomes high, and scattered light becomes small. This facilitates improvement in the image quality of the radiation image detector. Furthermore, the radiation image detector of the present invention is provided with the scan mechanism for moving the grid, and hence can take a phase contrast image. The use of the grid described above allows obtainment of the phase contrast image of high quality.

According to the grid manufacturing method of the present invention, the nonlinear single crystal substrate after being subjected to the polling process is applied to the polarization inversion for use in the formation of the grooves. Thus, it is possible to form the radiation absorbing portions with a high aspect ratio at high throughput and low costs. Only by doping with the phosphor, it is possible to easily impart a function as the scintillator to the grid. Furthermore, if the positions of the electrodes are not aligned between the first and second surfaces, the polarization inversion occurs in an oblique direction. Therefore, it is possible to easily form the radiation absorbing portions and the radiation transparent portions that converge to the focus of the radiation.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view of an X-ray imaging system;

FIG. 2A is a front view of a second grid;

FIG. 2B is a cross sectional view of the second grid taken on the line II-II of FIG. 2A;

FIG. 3 is a schematic cross-sectional view of an X-ray image detector;

FIG. 4 is a partial cross-sectional view of a photodetector of the X-ray image detector;

FIG. 5 is a block diagram of the X-ray image detector;

FIG. 6 is a cross-sectional view of a nonlinear single crystal substrate having periodic electrodes;

FIG. 7 is a schematic view of a vacuum chamber in which the nonlinear single crystal substrate is subjected to polarization inversion;

FIG. 8 is an explanatory view of the nonlinear single crystal substrate after the polarization inversion;

FIG. 9 is a cross-sectional view showing a state in which the nonlinear single crystal substrate is bonded to a support substrate;

FIG. 10 is a cross-sectional view showing a state in which non-reversed portions of the nonlinear single crystal substrate are removed by etching;

FIG. 11 is a cross-sectional view showing a state in which an X-ray absorbing material is charged into grooves formed by removal of the non-reversed portions;

FIG. 12 is a cross-sectional view showing a state in which reversed portions are doped with a phosphor;

FIG. 13 is a cross-sectional view showing a state in which the reversed portions emit light upon application of X-rays;

FIG. 14 is a schematic cross-sectional view of an X-ray image detector according to a second embodiment;

FIG. 15 is a schematic view of an X-ray imaging system using the X-ray image detector according to the second embodiment;

FIG. 16 is an explanatory view showing a state of polarization inversion according to a third embodiment; and

FIG. 17 is across-sectional of a grid according to the third embodiment.

### DESCRIPTION OF THE PREFERRED EMBODIMENTS

### First Embodiment

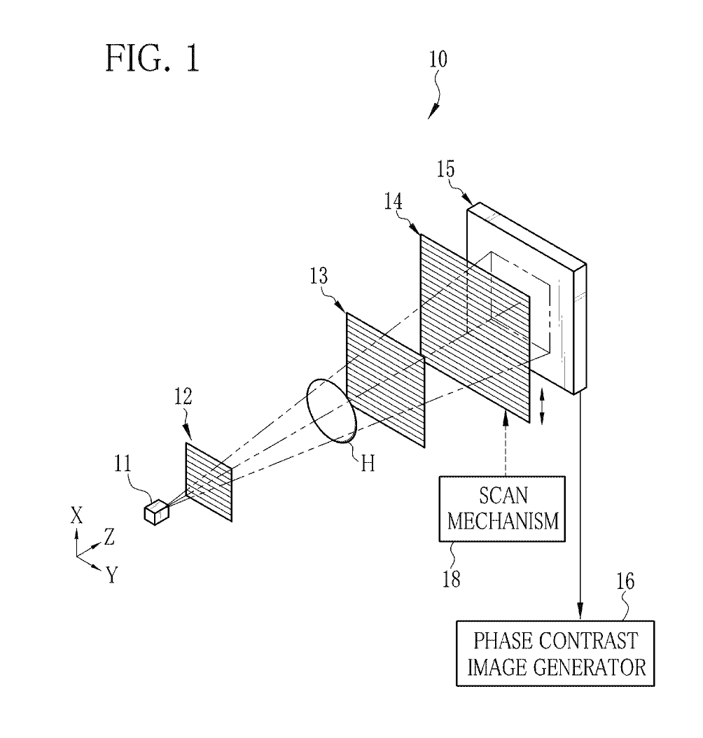

As shown in FIG. 1, an X-ray imaging system 10 is constituted of an X-ray source 11, a source grid 12, a first grid 13, a second grid 14, and an X-ray image detector 15, which are disposed in a Z direction being an X-ray propagation direction. The X-ray source 11 has, for example, a rotating anode type X-ray tube and a collimator for limiting an irradiation field of X-rays, and applies a cone beam of X-rays to a sample H. The X-ray image detector 15 is a flat panel detector (FPD) composed of semiconductor circuitry, for example, and is disposed behind the second grid 14. To the X-ray image detector 15, a phase contrast image generator 16 is connected to produce a phase contrast image from image data detected by the X-ray image detector 15.

The source grid 12, the first grid 13, and the second grid 14 being X-ray absorption grids are opposite to the X-ray source 11 in the Z direction. The sample H is disposed between the source grid 12 and the first grid 13. The distance between the first and second grids 13 and 14 is set at the minimum Talbot distance or less. In other words, the X-ray imaging system 10 according to this embodiment takes the phase contrast image by projection of the X-rays, without using the Talbot effect.

The second grid 14 and a scan mechanism 18 compose an intensity modulator of the present invention. In taking the phase contrast image, the scan mechanism 18 translationally moves the second grid 14 in a grid direction (X direction) at a scan pitch that is an integral submultiple (for example, ⅕) of a grid pitch of the second grid 14.

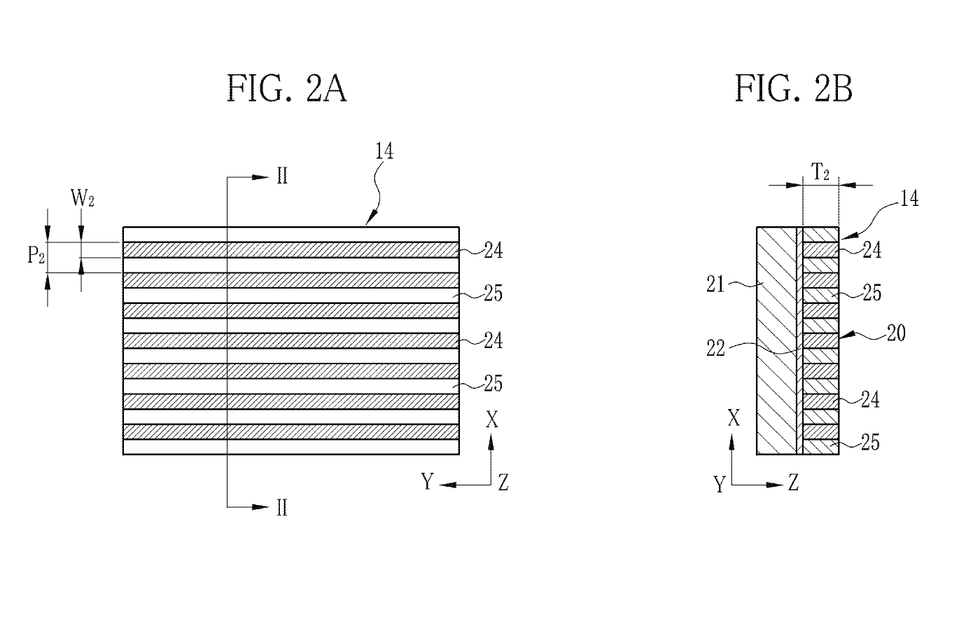

Taking the second grid 14 as an example, the structure of a grid will be described. As shown in FIGS. 2A and 2B, the second grid 14 is constituted of a grid layer 20 functioning as a grid, a support substrate 21 provided on the grid layer 20 on the side of the X-ray source 11, and a seed layer 22 provided between the grid layer 20 and the support substrate 21.

The grid layer 20 is provided with a plurality of X-ray absorbing portions 24 and X-ray transparent portions 25, which extend in a Y direction in a plane orthogonal to the Z direction. The X-ray absorbing portions 24 and the X-ray transparent portions 25 are alternately arranged in the X direction orthogonal to both the Z and Y directions, and compose a stripe-patterned grid. The X-ray absorbing portions 24 absorb (block) the X-rays emitted from the X-ray source 11, while the X-ray transparent portions 25 transmit the X-rays therethrough. As a result, a stripe-patterned image is formed.

The X-ray absorbing portions 24 are made of a material with high X-ray absorptivity, such as gold, platinum, silver, or lead. The X-ray transparent portions 25 are made of a material having lower X-ray absorptivity than that of the X-ray absorbing portions 24. The X-ray transparent portions 25 are made of nonlinear single crystal such as LiNbO₃, for example. Although the gold used in the X-ray absorbing portions 24 is diffused into the X-ray transparent portions 25 by heating, the gold is hard to diffuse into the single crystal, when compared to a polycrystal. Thus, using the single crystal in the X-ray transparent portions 25 brings about higher grid performance than that in using the polycrystal.

The support substrate 21 is made of a material having low X-ray absorptivity, as with the X-ray transparent portions 25, and stiffness enough to support the grid layer 20. The seed layer 22 is made of a conductive material, and is used as an electrode when forming the X-ray absorbing portions 24 by electrolytic plating. The seed layer 22 is much thinner than the grid layer 20 and the support substrate 21, and hardly affects the X-ray transparency of the grid.

The width W₂ and pitch P₂ of the X-ray absorbing portions 24 depend on the distance between the source grid 12 and the first grid 13, the distance between the first and second grids 13 and 14, the pitch of the X-ray absorbing portions of the first grid 13, and the like. By way of example, the width W₂ is approximately 2 to 20 μm, and the pitch P₂ is in the order of 4 to 40 μm. The thicker the thickness T₂ of the X-ray absorbing portions 24 in the Z direction, the higher the X-ray absorptivity becomes. However, the thickness T₂ of the X-ray absorbing portions 24 is in the order of 100 to 200 μm, for example, in consideration of vignetting of the cone beam of X-rays emitted from the X-ray source 11. In this embodiment, the X-ray absorbing portions 24 have a width W₂ of 2.5 μm, a pitch P₂ of 5 μm, a thickness T₂ of 100 μm, and an aspect ratio of 40, for example.

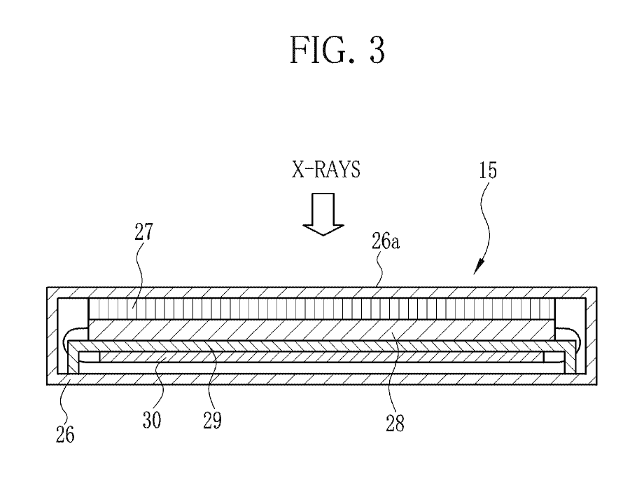

As shown in FIG. 3, the X-ray image detector 15 is provided with a case 26 of an approximately box shape. The case 26 is made of an X-ray transparent material. The case 26 has an incident surface 26a at its rectangular top surface to which the X-rays passed through the sample H are applied. The case 26 contains a scintillator 27, a photodetector 28, a base 29, a main circuit board 30, and the like in this order from the side of the incident surface 26a along the propagation direction of the X-rays passed through the sample H. The scintillator 27 is made of, for example, CsI:Tl (cesium iodide doped with thallium), CsI:Na (cesium iodide activated with sodium), GOS (Gd₂O₂S: Tb), or the like. The scintillator 27 absorbs the X-rays that have passed through the sample H and been applied through the case 26 and emits light.

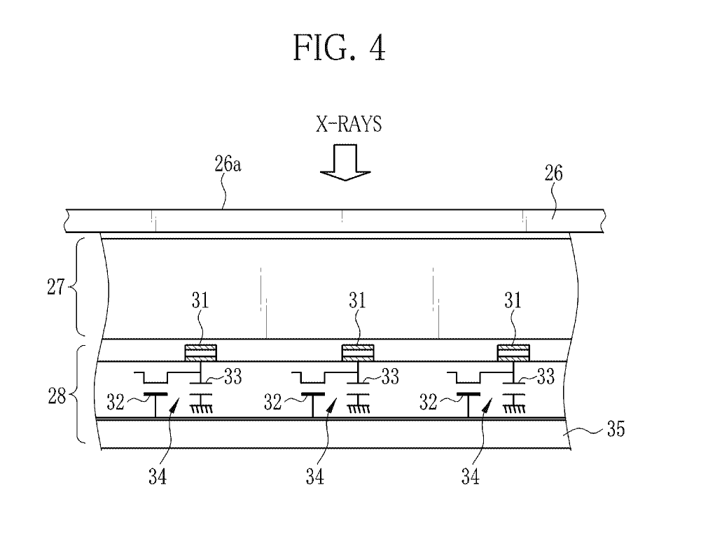

The photodetector 28 detects the light projected from a light exit side of the scintillator 27. As shown in FIG. 4, the photodetector 28 is composed of a TFT active matrix substrate (hereinafter called TFT substrate) in which a plurality of photoelectric converters 31 and pixels 34 are formed into a matrix in a flat and rectangular insulation substrate 35. Each photoelectric converter 31 is composed of a photodiode (PD) and the like. Each pixel 34 includes a thin film transistor (TFT) 32 and a capacitor 33.

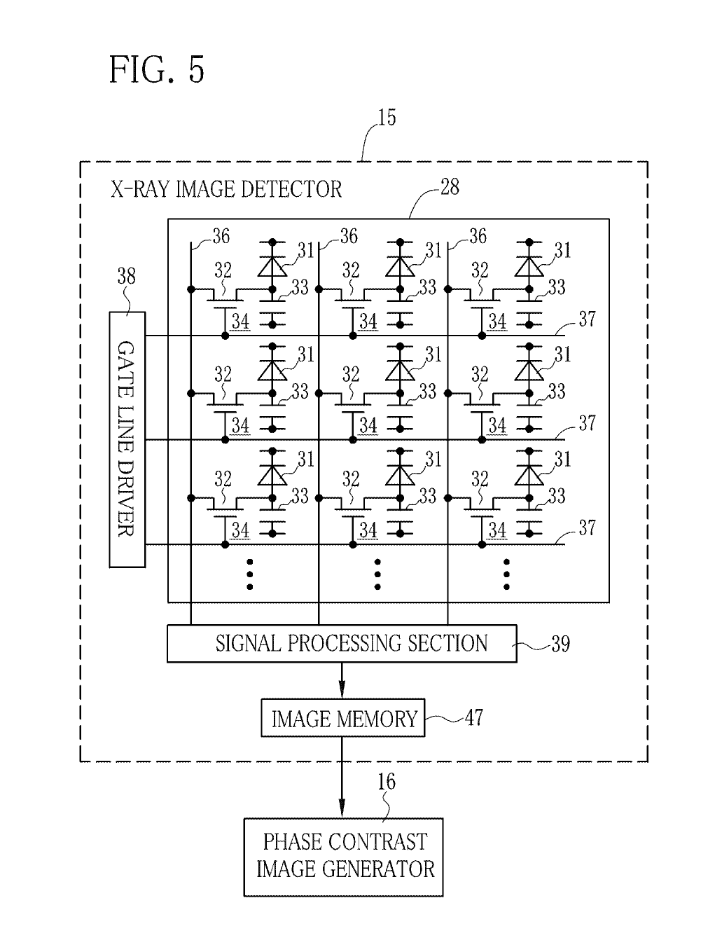

As shown in FIG. 5, the photodetector 28 is provided with a plurality of gate lines 37 and data lines 36. The gate line 37 extends in a certain direction (row direction) and is used for turning on and off each individual TFT 32. The data line 36 extends in a direction (column direction) orthogonal to the certain direction, and is used for reading out electric charge accumulated in the capacitor 33 through the TFT 32, when the TFT 32 is turned on. Every gate line 37 in the photodetector 28 is connected to a gate line driver 38. Every data line 36 is connected to a signal processing section 39. The gate line driver 38 and the signal processing section 39 are laid out in the main circuit board 30, and are connected to the photodetector 28 via a flexible board.

When the X-rays having passed through the sample H are applied to the X-ray image detector 15, the scintillator 27 emits the light by an amount varying from area to area in accordance with the amount of the X-rays incident upon a corresponding position of the incident surface 26a. Then, in each pixel 34, the photoelectric converter 31 produces the electric charge by an amount depending on the amount of the light emitted from a corresponding area of the scintillator 27, and the capacitor 33 accumulates the electric charge.

After every pixel 34 accumulates the electric charge in its capacitor 33, as described above, the TFTs 32 of the pixels 34 are successively turned on by a signal supplied from the gate line driver 38 through the gate lines 37 on a row-by-row basis. Thus, the electric charge accumulated in the capacitors 33 connected to the TFTs 32 being turned on flows into the data lines 36, and is inputted to the signal processing section 39 as an analog electric signal. Thereby, the electric charge accumulated in the capacitor 33 of every pixel 34 is successively read out on a row-by-row basis.

The signal processing section 39 includes one amplifier and one sample-hold circuit for each data line 36. The electric signal transmitted along each data line 36 is amplified by the amplifier, and held by the sample-hold circuit. The outputs of every sample-hold circuit are connected to a multiplexer and an A/D converter in series. The electric signals held by the individual sample-hold circuits are inputted to the multiplexer in series, and converted by the A/D converter into digital image data.

The signal processing section 39 is connected to an image memory 47. The image data outputted from the A/D converter of the signal processing section 39 is successively stored in the image memory 47. The image memory 47 has a capacity of two or more frames of image data. Whenever a radiographic image is captured, obtained image data is successively written to the image memory 47. The phase contrast image generator 16 reads out the image data from the image memory 47, and produces the phase contrast image.

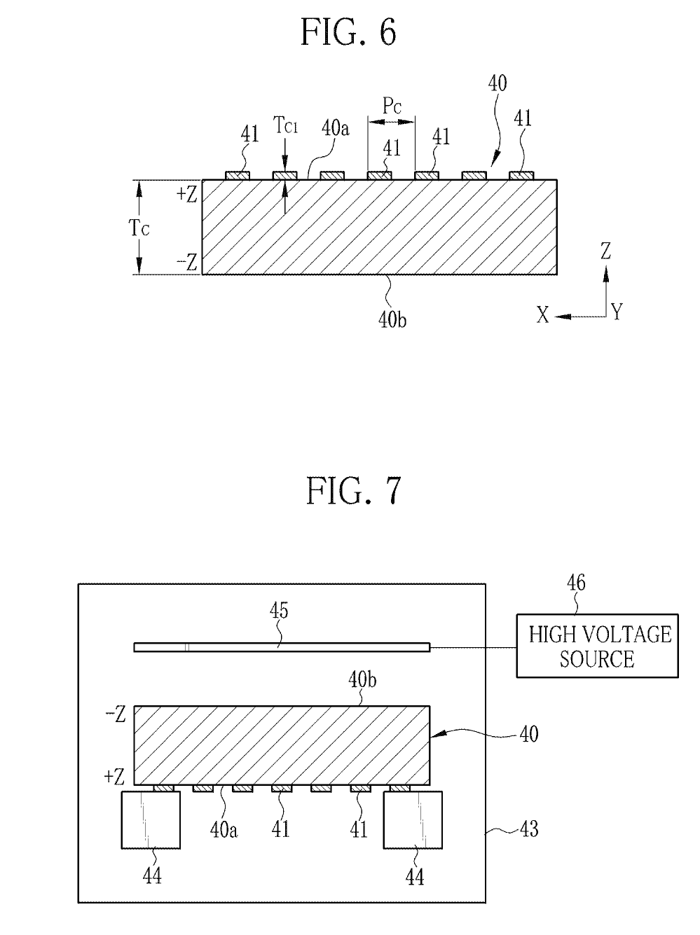

Next, a manufacturing method of the second grid 14 will be described. In a first step, as shown in FIG. 6, periodic electrodes 41 with a pattern of many lines extending in the Y direction and being arranged in the X direction at predetermined intervals are formed out of Ta (tantalum) on a first surface 40a of a nonlinear single crystal substrate 40. The nonlinear single crystal substrate 40 is made of MgO-LN i.e. LiNbO₃ doped with MgO of 5 mol %. This nonlinear single crystal substrate 40 is subjected to a polling process and an optical polishing process at its Z surfaces so that a nonlinear optical constant is effectively available. Thereby, the first surface 40a of the nonlinear single crystal substrate 40 becomes a +Z surface, while the opposite second surface 40b becomes a −Z surface.

The nonlinear single crystal substrate 40 can be made of single crystal composed of two or more types of elements, such as LiTaO₃, KTiOPO₄, β-BaB₂O₄, LiB₂O₃, BiGeO, BiSiO, BiTiO, CdWO, PbWO, GaAs, SiC, CdTe, CdSe, ZnO, TiBaO, TiPbO, or the like, in addition to the LiNbO₃ as described above.

To form the periodic electrodes 41, for example, a Ta film is formed on the entire first surface 40a of the nonlinear single crystal substrate 40. Then, a resist mask having the same line pattern as that of the periodic electrodes 41 is formed on the Ta film by a conventional photolithography technique, and the Ta film is etched through the resist mask. The periodic electrodes 41 are coupled and shorted to each other at their ends. By way of example, the nonlinear single crystal substrate 40 has a thickness Tc of 0.4 mm, and the periodic electrodes 41 have a thickness Tc₁ of 0.1 μm and a pitch Pc of 5 μm.

In the next step, as shown in FIG. 7, the nonlinear single crystal substrate 40 is put in a vacuum chamber 43 such that the first surface 40a faces downward and a heater 44 supports the periodic electrodes 41. A corona discharge wire 45 is disposed above the nonlinear single crystal substrate 40 with being aimed at the second surface 40b. The corona discharge wire 45 is connected to a high voltage source 46.

The vacuum chamber 43 is depressurized by a not-shown vacuum pump to 1×10⁻⁴ Pa, for example. The nonlinear single crystal substrate 40 is heated by the heater 44 to 100° C., for example. Then, a voltage of −6 kV is applied for two seconds from the high voltage source 46 to the nonlinear single crystal substrate 40 via the corona discharge wire 45.

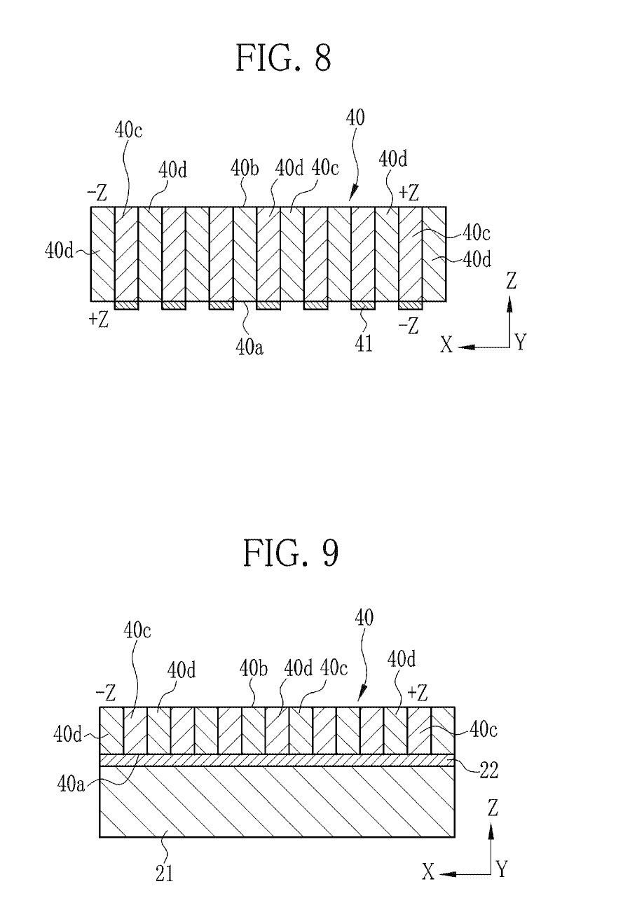

Through the above steps, as shown in FIG. 8, the direction of spontaneous polarization of the nonlinear single crystal substrate 40 is reversed at portions facing to the periodic electrodes 41. Thus, reversed portions 40c are formed at a pitch Pc of 5 μm. The direction of polarization of the reversed portions 40c is opposite to that of non-reversed portions 40d. In other words, the +Z surface is assigned to the first surface 40a in the non-reversed portions 40d, while the −Z surface is assigned to the first surface 40a in the reversed portions 40c. Since polarization inversion is carried out along a crystallographic axis of the nonlinear single crystal, it is possible to form a periodic structure of extremely high verticality with the high aspect ratio. Note that, refer to Japanese Patent Laid-Open Publication No. 2002-334977 and Applied Physics Letters Vol. 69, No. 18, pate 2629 written by A. Harada et al. in 1996 for the detailed procedure of the polarization inversion using corona charging.

As shown in FIG. 9, after the periodic electrodes 41 are removed, the first surface 40a of the nonlinear single crystal substrate 40 is bonded to the support substrate 21. Then, the nonlinear single crystal substrate 40 is thinned to the order of 100 μm, for example, by a polishing device for CMP or the like. Accordingly, only the second surface 40b of the nonlinear single crystal substrate 40 is exposed outside. In the second surface 40b, the +Z surfaces of the reversed portions 40c and the −Z surfaces of the non-reversed portions 40d are arranged. By way of example, Au—Au bonding is used in bonding between the nonlinear single crystal substrate 40 and the support substrate 21, by which gold is deposited on both the nonlinear single crystal substrate 40 and the support substrate 21 and put together. In this case, the gold used for the bonding is made into the seed layer 22. The support substrate 21 is made of a material with low X-ray absorptivity. The support substrate 21 is preferably made of, for example, glass, quartz, alumina, GaAs, Ge, or the like, and more preferably made of silicon.

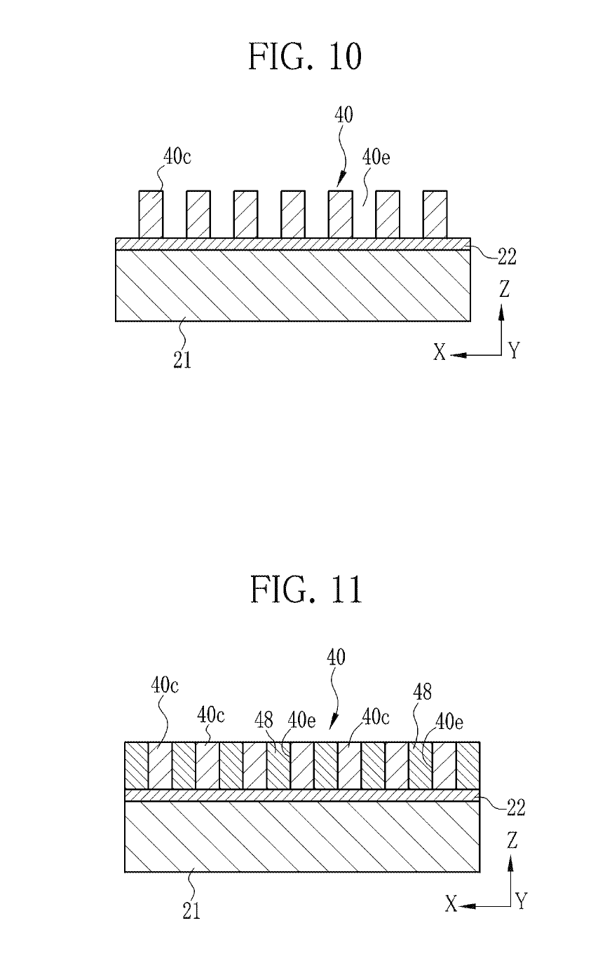

In the next step, the nonlinear single crystal substrate 40 is subjected to wet etching. The +Z surface of the nonlinear single crystal substrate 40 is an etching resistance surface, in other words, an etching speed is much slower in the +Z surface than in the −Z surface. Accordingly, only the non-reversed portions 40d of the nonlinear single crystal substrate 40 are removed, while the reversed portions 40c remain. As a result, as shown in FIG. 10, a plurality of grooves 40e with the high aspect ratio are formed between the reversed portions 40c. The wet etching of the nonlinear single crystal substrate 40 uses a mixed solution of a hydrofluoric acid and a nitric acid in proportions of 1:2, for example.

As shown in FIG. 11, in the next step, the grooves 40e formed between the reversed portions 40c of the nonlinear single crystal substrate 40 are filled with an X-ray absorbing material 48 such as gold by electrolytic plating. In the electrolytic plating, a current terminal is connected to the seed layer 22. A combination of the nonlinear single crystal substrate 40 and the support substrate 21 is immersed in a plating solution, and another electrode (positive electrode) is disposed in a position opposite thereto. When electric current flows between the seed layer 22 and the positive electrode, metal ions contained in the plating solution are deposited on the patterned substrate so as to fill the grooves 40e with the X-ray absorbing material 48. Thereby, the second grid 14 as shown in FIGS. 2A and 2B that has the X-ray absorbing portions 24 made of the gold and the X-ray transparent portions 25 made of the reversed portions 40c is completed.

Just like the second grid 14, the source grid 12 and the first grid 13 are composed of a grid layer and a support substrate. The grid layer of the source grid 12 and the first grid 13 includes X-ray absorbing portions and X-ray transparent portions that extend in the Y direction and are alternately arranged in the X direction. The X-ray transparent portions are composed of reversed portions, as with the grid layer 20 of the second grid 14. As just described, the source grid 12 and the first grid 13 have substantially the same structure as that of the second grid 14 except for the width and pitch of the X-ray absorbing portions and the X-ray transparent portions in the Y direction, the thickness in the Z direction, and the like, so the detailed description about their structures will be omitted. Also, since the source grid 12 and the first grid 13 are manufactured in substantially the same way as the second grid 14, the detailed description about their manufacturing methods will be omitted.

Next, the operation of the X-ray imaging system 10 will be described. Since the X-rays emitted from the X-ray source 11 are partly blocked by the X-ray absorbing portions of the source grid 12, an effective focus size in the X direction is reduced, and many line sources (dispersed light sources) are formed in the X direction. When the X-rays from each line source formed by the source grid 12 pass through the sample H, the phase of the X-rays is changed. Subsequently, when the X-rays pass through the first grid 13, a fringe image (first periodic pattern image) including transmission phase information of the sample H, which is determined by the refractive index of the sample H and the length of a transmission optical path, is formed. The fringe images of every line source are projected to the second grid 14, and are combined (superimposed) in the position of the second grid 14. Thus, it is possible to improve the quality of the phase contrast image without reducing the intensity of the X-rays.

The second grid 14 modulates the intensity of the fringe image. The fringe image (second periodic pattern image) after the intensity modulation is detected by a fringe scanning method, for example. In the fringe scanning method, the scan mechanism 18 intermittently moves the second grid 14 relative to the first grid 13 by a scan pitch that is an equal division (for example, one-fifth) of the grid pitch along a grid surface with respect to an X-ray focus. Whenever the second grid 14 is stopped between the intermittent movements, the X-ray source 11 applies the X-rays to the sample H, and the X-ray image detector 15 detects the second periodic pattern image. The phase contrast image generator 16 calculates a differential phase image (corresponding to the angular distribution of the X-rays refracted by the sample H) from a phase shift amount (shift in phase between the presence of the sample H and the absence of the sample H) of pixel data of each pixel of the X-ray image detector 15. After that, the phase contrast image generator 16 integrates the differential phase image along a fringe scanning direction to obtain the phase contrast image of the sample H.

As described above, according to the source grid 12, the first grid 13, and the second grid 14 of this embodiment, the X-ray transparent portions are made of the nonlinear single crystal composed of the two or more types of elements. Therefore, the gold used in the X-ray absorbing portions is less diffused into the X-ray transparent portions, as compared with a case where the X-ray transparent portions are made of single crystal composed of a single element, such as silicon. This is because the single crystal composed of the single element easily reacts due to a low bonding strength and tends to allow the diffusion, while the nonlinear single crystal composed of the two or more elements has a higher bonding strength between the different types of elements than that between the single type of elements. Thus, using the nonlinear single crystal composed of the two or more types of elements facilitates preventing the diffusion of the gold.

Also, the grooves 40e to be the X-ray absorbing portions 24 are formed by the polarization inversion and the wet etching of the nonlinear single crystal. Thus, it is possible to form the grooves with the high aspect ratio at high throughput and low costs, as compared with a case of using a LIGA method or dry etching of silicon.

### Second Embodiment

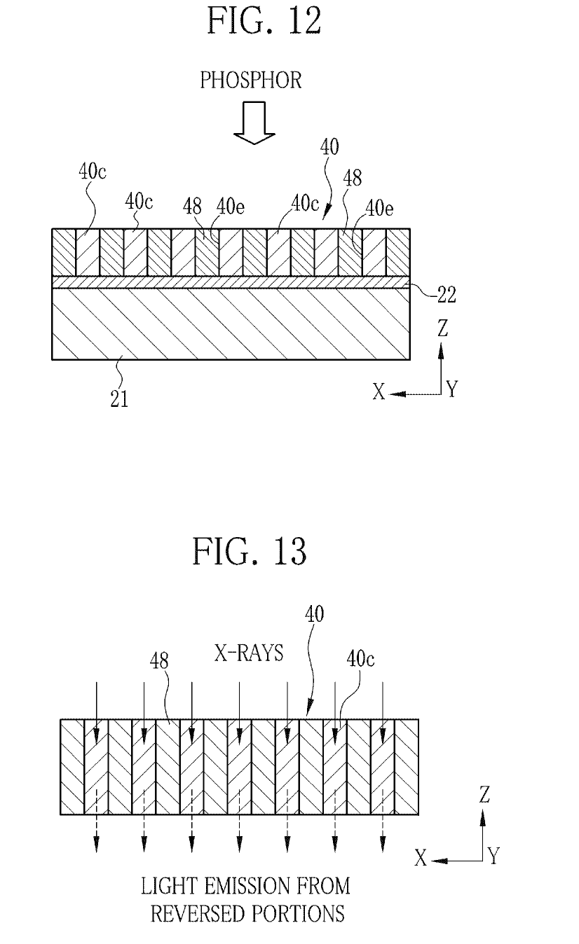

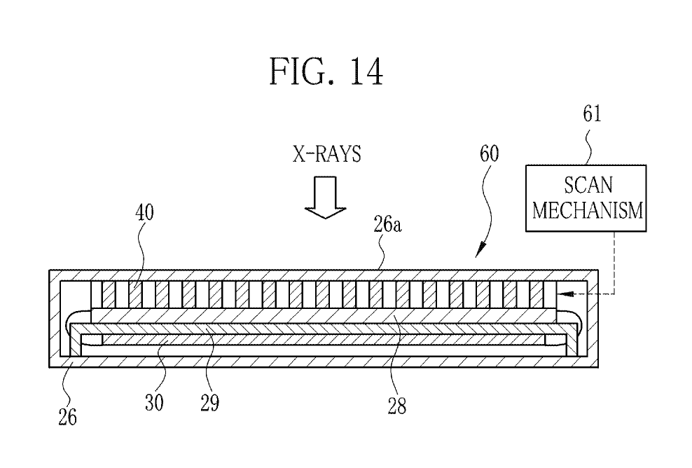

In a second embodiment, the nonlinear single crystal substrate doped with a phosphor is integrated into the X-ray image detector, and is used as the second grid and the scintillator. As shown in FIG. 12, before or after the X-ray absorbing material 48 is charged into the grooves 40e of the nonlinear single crystal substrate 40, the reversed portions 40c may be doped with the phosphor. In another case, the nonlinear single crystal substrate doped with the phosphor may be manufactured, and then the X-ray absorbing material 48 may be charged into the grooves 40e. After that, the seed layer 22 is removed to take out the nonlinear single crystal substrate 40. As shown in FIG. 13, this nonlinear single crystal substrate 40 emits light upon application of the X-rays. Then, as shown in FIG. 14, the nonlinear single crystal substrate 40 is contained in an X-ray image detector 60, so the nonlinear single crystal substrate 40 functions as the second grid and the scintillator. In the case of using crystal composed of two or more types of elements such as GdOS:Pr,Ce, LuSiO:Ce, YSiO:Ce, YAlO:Ce, LuAlO:Pr, BiGeO, BiSiO, or BiTiO, the reversed portions can emit light upon application of the X-rays without doping of the phosphor.

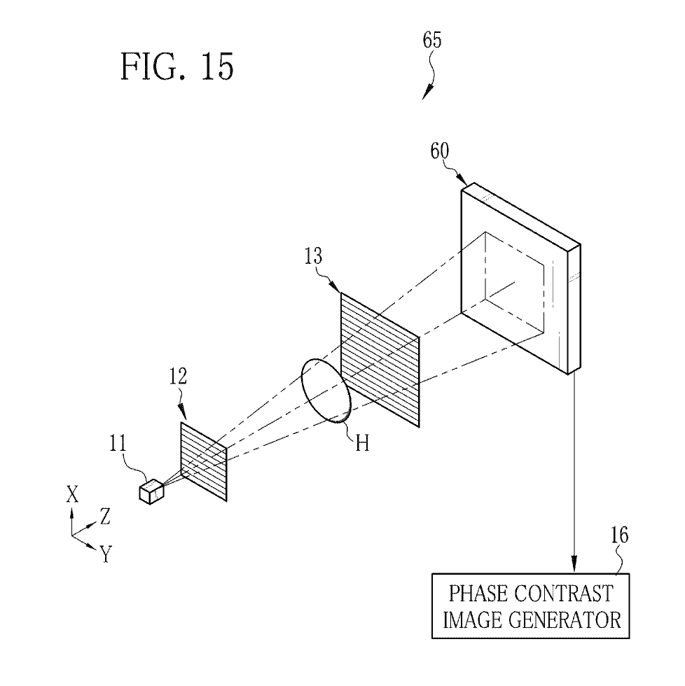

The use of the X-ray image detector 60 having the nonlinear single crystal substrate 40 eliminates the need for providing the second grid 14, and allows the composition of an X-ray imaging system 65 without the second grid 14, as shown in FIG. 15, resulting in reduction in size and cost. Since the single crystal has high filling density, luminous efficiency is high and scattered light is small. This facilitates improvement in the image quality of the X-ray image detector 60. Note that, a scan mechanism 61 that moves the nonlinear single crystal substrate 40 in a periodic direction of the X-ray absorbing portions and the X-ray transparent portions is preferably assembled into the X-ray image detector 60, so as to allow obtainment of the phase contrast image using the fringe scanning method.

### Third Embodiment

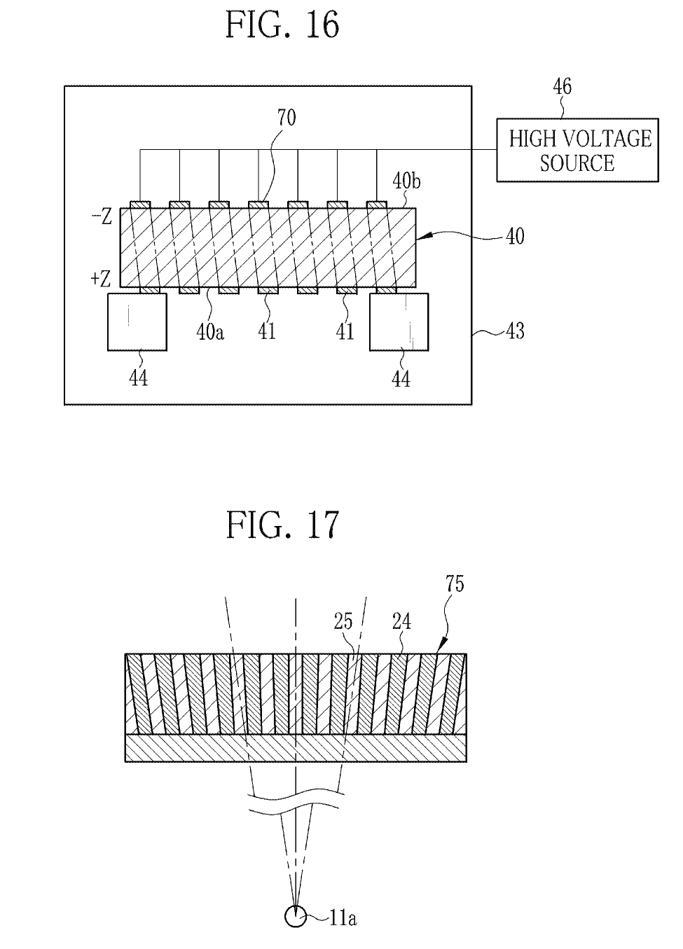

In the above embodiments, the polarization inversion is performed straight along a thickness direction of the nonlinear single crystal substrate 40. However, as shown in FIG. 16, second periodic electrodes 70 with different periodicity from that of the periodic electrodes 41 of the first surface 40a maybe formed in the second surface 40b of the nonlinear single crystal substrate 40. After that, voltage is applied from the high voltage source 46 to the second periodic electrodes 70, so the polarization inversion occurs between the periodic electrode 41 and the second periodic electrode 70. According to this embodiment, as shown in a grid 75 of FIG. 17, the X-ray absorbing portions 24 and the X-ray transparent portions 25 can be inclined in a grid surface, such that the X-rays emitted from behind the grid 75 and passed through the X-ray transparent portions 25 converge to the X-ray focus 11a being an X-ray generation point of the X-ray source 11. Thereby, it is possible to reduce the vignetting of the cone beam of X-rays emitted from the X-ray source 11.

The above embodiments are described with taking as an example the stripe-patterned one-dimensional grid, which has the X-ray absorbing portions and the X-ray transparent portions extending in the first direction and being alternately arranged in the second direction. However, the present invention is applicable to a two-dimensional grid having X-ray absorbing portions and X-ray transparent portions arranged in two directions. Furthermore, the sample is disposed between the source grid and the first grid in this embodiment. However, even if the sample is disposed between the first and second grids, the phase contrast image can be produced in a like manner. The X-ray imaging system is provided with the source grid, but the present invention is applicable to an X-ray imaging system that does not use the source grid. The above embodiments can be combined with each other as long as no contradiction arises.

In the above embodiments, the first and second grids linearly project the X-rays that have passed through their X-ray transparent portions. However, the present invention is not limited to this structure, and the first and second grids produce the so-called Talbot effect by diffraction of the X-rays (refer to International Publication No. WO 2004/058070). In this case, the distance between the first and second grids is set at the Talbot distance. The first grid may be a phase grid having the relatively low aspect ratio, instead of the absorption grid.

In the above embodiments, the phase contrast image is produced from the plural fringe images that are subjected to the intensity modulation by the second grid and are detected by the fringe scanning method. However, there is known an X-ray imaging system that produces the phase contrast image by single image capturing operation. According to an X-ray imaging system disclosed in International Publication No. WO 2010/050483, for example, the X-ray image detector detects a moiré produced by the first and second grids, and the intensity distribution of the detected moiré is subjected to the Fourier transformation to obtain a spatial frequency spectrum. From this spatial frequency spectrum, a spectrum corresponding to a carrier frequency is separated, and the spectrum is subjected to the inverse Fourier transformation to obtain the differential phase image. The grid of the present invention may be used as at least one of the first and second grids of this type of X-ray imaging system.

Another X-ray imaging system for producing the phase contrast image by the single image capturing operation is provided with a direct conversion type of X-ray image detector as the intensity modulator, instead of the second grid. The direct conversion type of X-ray image detector is constituted of a conversion layer for converting the X-rays into the electric charge, and a charge collection electrode for collecting the electric charge converted by the conversion layer. In this X-ray imaging system, for example, the charge collection electrode of each pixel is composed of a plurality of linear electrode groups that are arranged out of phase with one another. Each linear electrode group includes electrically connected linear electrodes, which are arranged in approximately the same period as that of the periodic pattern of the fringe image formed by the first grid. By separately controlling the linear electrode groups to collect the electric charge, plural fringe images are obtained by the single image capturing operation, and the phase contrast image is produced from the plural fringe images (refer to U.S. Pat. No. 7,746,981 corresponding to Japanese Patent Laid-Open Publication No. 2009-133823). The grid of the present invention may be used as the first grid of this type of X-ray imaging system.

In further another X-ray imaging system for producing the phase contrast image by the single image capturing operation, the first and second grids are disposed such that the extending direction of the X-ray absorbing portions and the X-ray transparent portions is relatively inclined by a predetermined angle between the first and second grids. A moiré period area, which occurs in the extending direction due to the inclination, is divided, and an image of each divided area is captured to obtain plural fringe images at different relative positions between the first and second grids. From the plural fringe images, the phase contrast image is produced. The grid of the present invention may be used as at least one of the first and second grids of this type of X-ray imaging system.

The use of an optical reading type of X-ray image detector eliminates the need for providing the second grid in the X-ray imaging system. In this system, the optical reading type of X-ray image detector used as the intensity modulator includes a first electrode layer, a photoconductive layer, a charge accumulation layer, a second electrode layer that are laminated in this order. The first electrode layer transmits the periodic pattern image formed by the first grid. The photoconductive layer produces the electric charge upon application of the periodic pattern image transmitted through the first electrode layer. The charge accumulation layer accumulates the electric charge produced by the photoconductive layer. In the second electrode layer, many linear electrodes for transmitting scan light are arranged. By scanning with the scan light, an image signal of each pixel corresponding to each linear electrode is read out. Since the charge accumulation layer takes the form of a grid having a pitch narrower than an arrangement pitch of the linear electrodes, the charge accumulation layer functions as the second grid. The grid of the present invention may be used as the first grid of this type of X-ray imaging system.

The embodiments described above are applicable not only to the radiation imaging system for medical diagnosis, but also to other types of radiation imaging systems for industrial use, nondestructive inspection, and the like. The present invention is also applicable to a grid for removing scattered light in radiography. Furthermore, in the present invention, gamma-rays may be used as radiation instead of the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A grid for radiography comprising:
a plurality of radiation transparent portions made of nonlinear single crystal; and
a plurality of radiation absorbing portions arranged alternately to said radiation transparent portions.

2. The grid according to claim 1, wherein said radiation transparent portions are doped with a phosphor, and emit light upon application of radiation.

3. The grid according to claim 1, wherein said radiation transparent portions and said radiation absorbing portions are inclined such that radiation incident from behind said grid converges to a focus of said radiation.

4. The grid according to claim 1, wherein said radiation absorbing portions and said radiation transparent portions extend in a first direction, and are alternately arranged in a second direction orthogonal to said first direction.

5. A radiation image detector comprising:
a grid including a plurality of radiation transparent portions and a plurality of radiation absorbing portions, said radiation transparent portions being made of nonlinear single crystal doped with a phosphor to emit light upon application of radiation; and
a photodetector for detecting said light emitted from said grid.

6. The radiation image detector according to claim 5, further comprising:
a scan mechanism for moving said grid at a predetermined pitch in an arrangement direction of said radiation absorbing portions and said radiation transparent portions.

7. A radiation imaging system comprising:
a radiation source for emitting radiation;
a first grid for passing said radiation from said radiation source to form a first periodic pattern image, said first grid including alternately arranged first radiation transparent portions and first radiation absorbing portions, said first radiation transparent portions being made of nonlinear single crystal;
an intensity modulator for applying intensity modulation to said first periodic pattern image at least one relative position out of phase with said first periodic pattern image to form a second periodic pattern image;
a radiation image detector for detecting said second periodic pattern image; and
a computing section for imaging phase information of said radiation based on said second periodic pattern image detected by said radiation image detector.

8. The radiation imaging system according to claim 7, wherein said intensity modulator includes:
a second grid having alternately arranged second radiation transparent portions and second radiation absorbing portions, said second radiation transparent portions being made of nonlinear single crystal; and
a scan mechanism for moving one of said first and second grids at a predetermined pitch in a periodic direction of grid structure to set said first and second grids at said relative position.

9. The radiation imaging system according to claim 7, further comprising:
a third grid disposed between said radiation source and said first grid, for partly blocking said radiation emitted from said radiation source to form many line sources, said third grid including alternately arranged third radiation transparent portions and third radiation absorbing portions, said third radiation transparent portions being made of nonlinear single crystal.

10. The radiation imaging system according to claim 7, wherein said radiation image detector includes:
(A) a second grid having second radiation transparent portions and second radiation absorbing portions, said second radiation transparent portions being made of nonlinear single crystal doped with a phosphor and emitting light upon application of said radiation;
(B) a photodetector for detecting said light emitted from said second grid; and
said intensity modulator is a scan mechanism for moving said second grid at a predetermined pitch in an arrangement direction of said second absorbing portions and said second transparent portions.

11. A method for manufacturing a grid for radiography comprising the steps of:
forming a plurality of first electrodes on a first surface of a nonlinear single crystal substrate after being subjected to a polling process;
applying voltage to said nonlinear single crystal substrate from a side of a second surface opposite to said first surface, to reverse a direction of polarization of said nonlinear single crystal substrate in portions facing to said first electrodes;
etching said nonlinear single crystal substrate, and removing non-reversed portions where polarity inversion has not occurred while keeping reversed portions where said polarity inversion has occurred, by taking advantage of difference in an etching rate between said non-reversed portions and said reversed portions; and
charging a radiation absorbing material into space left after the removal of said non-reversed portions.

12. The method according to claim 11, further comprising the step of:
doping said reversed portions with a phosphor.

13. The method according to claim 11, further comprising the step of:
forming second electrodes on said second surface of said nonlinear single crystal substrate with periodicity different from that of said first electrodes, said voltage being applied to said second electrodes.
